(19) United States
(12) Patent Application Publication
(10) Pub. No.: US 2024/0181518 A1
(43) Pub. Date: Jun. 6, 2024

(54) ELECTRICITY-GENERATING ASSEMBLY FABRICATION APPARATUS AND METHOD

(71) Applicants: HYUNDAI MOTOR COMPANY, Seoul (KR); KIA CORPORATION, Seoul (KR)

(72) Inventors: Min Jin Kim, Seoul (KR); Hyun Gak Yang, Daejeon (KR)

(21) Appl. No.: 18/195,732

(22) Filed: May 10, 2023

(30) Foreign Application Priority Data
Dec. 5, 2022 (KR) 10-2022-0167270

(51) Int. Cl. B21D 39/03; H01M 8/1004

(52) U.S. Cl. CPC B21D 39/031; H01M 8/1004

(57) ABSTRACT

An electricity-generating assembly (EGA) fabrication apparatus includes a downstream press. The downstream press includes an attachment roll configured to attach a second gas diffusion layer (GDL) to a second surface of a membrane-electrode assembly (MEA) with a first GDL attached to a first surface of the MWA. The attachment roll is rotatable and is configured to receive the second GDL having a predetermined size and attach the GDL to the second surface of the MEA at predetermined distances.

### CROSS REFERENCE TO RELATED APPLICATIONS

The present application claims priority to Korean Patent Application No. 10-2022-0167270, filed Dec. 5, 2022, the entire contents of which are incorporated herein for all purposes by this reference.

### BACKGROUND

### Field

The present disclosure relates generally to a fuel cell and, more particularly, to an electricity-generating assembly (EGA) fabrication apparatus and method.

### Description of the Related Art

A fuel cell generates current by oxidation of fuel, such as hydrogen. In this regard, a unit cell of the fuel cell includes an electricity-generating assembly (EGA) that generates electricity.

The EGA includes a membrane-electrode assembly (MEA) and gas diffusion layers (GDLs). The MEA in which electrochemical reactions occur includes an electrolyte membrane formed of a polymer and a positive electrode and a negative electrode provided on both sides of the electrolyte membrane. In addition, the GDLs are disposed at an outer side of the positive electrode and the negative electrode of the MEA, respectively.

### SUMMARY

Accordingly, the present disclosure has been made keeping in mind the above problems occurring in the related art, and the present disclosure is intended to propose an electricity-generating assembly (EGA) fabrication apparatus and method, in which the EGA may be fabricated using a continuous process.

Also, provided are an EGA fabrication apparatus and method, in which mass productivity is improved and fabrication cost is reduced.

The objective of the present disclosure is not limited to the aforementioned description, and other objectives not explicitly disclosed herein will be clearly understood by those skilled in in the art from the description provided hereinafter.

In order to achieve at least one of the above objectives and perform characteristic functions of the present disclosure to be described later, the present disclosure has the following features.

According to an embodiment of the present disclosure, an electricity-generating assembly (EGA) fabrication apparatus may include a downstream press, wherein the downstream press may include an attachment roll configured to attach a second gas diffusion layer (GDL) to a second surface of a membrane-electrode assembly (MEA) with a first GDL attached to a first surface of the MWA. The attachment roll may be rotatable and configured to receive the second GDL having a predetermined size and attach the GDL to the second surface of the MEA at predetermined distances.

According to an embodiment of the present disclosure, an electricity-generating assembly (EGA) fabrication method may include continuously supplying a membrane-electrode assembly (EGA), attaching a first gas diffusion layer (GDL) to a first surface of the MEA using an upstream press disposed upstream in a flow direction of the MEA, wherein the first GDL is continuously supplied, attaching a second GDL to a second surface of the MEA using a downstream press disposed downstream in the flow direction of the MEA, and obtaining an EGA by attaching the second GDL to the MEA.

According to the present disclosure, the apparatus and method for fabricating an EGA may fabricate an EGA using a continuous process.

The apparatus and method for fabricating an EGA may have improved mass productivity and reduce fabrication costs.

Effects obtainable from the present disclosure are not limited to the aforementioned effects, and other effects not explicitly disclosed herein will be clearly understood by those skilled in in the art from the description provided hereinafter.

### BRIEF DESCRIPTION OF THE FIGURES

The above and other objectives, features, and other advantages of the present disclosure will be more clearly understood from the following detailed description when taken in conjunction with the accompanying drawings, in which:

FIG. 1 is a cross-sectional view illustrating an EGA;

FIG. 2 illustrates an apparatus for fabricating an EGA fabrication apparatus according to an embodiment of the present disclosure;

FIG. 3 is a top view illustrating an upper GDL during punching according to an embodiment of the present disclosure;

FIG. 4 illustrates a case in which the punching roll according to an embodiment of the present disclosure is in the original position;

FIG. 5 illustrates a case in which the punching roll according to an embodiment of the present disclosure rotates towards a punching position;

FIG. 6 illustrates a punching plate a punching blade located in part S1 in FIG. 4 according to an embodiment of the present disclosure;

FIG. 7 is a perspective view illustrating the attachment roll according to an embodiment of the present disclosure;

FIG. 8 is a perspective view illustrating the conduit attached to the attachment roll according to an embodiment of the present disclosure;

FIG. 9 is a schematic cross-sectional view illustrating the attachment roll according to an embodiment of the present disclosure;

FIG. 10 is a partial perspective view illustrating the attachment roll according to an embodiment of the present disclosure; and

FIG. 11 is a flowchart illustrating an EGA fabrication method according to an embodiment of the present disclosure.

### DETAILED DESCRIPTION

Specific structural and functional descriptions of embodiments of the present disclosure disclosed herein are only for illustrative purposes of embodiments of the present disclosure. The present disclosure may be embodied in many different forms without departing from the spirit and significant characteristics of the present disclosure. In addition, the present disclosure is intended to cover not only the exemplary embodiments, but also various alternatives, modifications, equivalents, and other embodiments that may be included within the spirit and scope of the present disclosure.

It will be understood that, although the terms “first,” “second,” etc., may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled,” “connected,” or “linked” to another element, it can be directly coupled or connected to the other element or intervening elements may be present therebetween. In contrast, it should be understood that when an element is referred to as being “directly coupled,” “directly connected,” or “directly connected” to another element, there are no intervening elements present. Other expressions that explain the relationship between elements, such as “between,” “directly between,” “adjacent to,” or “directly adjacent to” should be construed in the same way.

Throughout the specification, the same reference numerals will refer to the same or like parts. The terminologies used herein are for the purpose of describing particular embodiments only and are not intended to limit the present disclosure. As used herein, singular forms are intended to include plural forms as well, unless not explicitly stated to the contrary unless the context clearly indicates otherwise. It will be further understood that the terms “comprise,” “include,” “have,” etc., when used in this specification, specify the presence of stated features, integers, steps, operations, elements, components, and/or combinations thereof but do not preclude the presence or addition of one or more other features, integers, steps, operations, elements, components, and/or combinations thereof.

Hereinafter, the present disclosure will be described in detail with reference to the accompanying drawings.

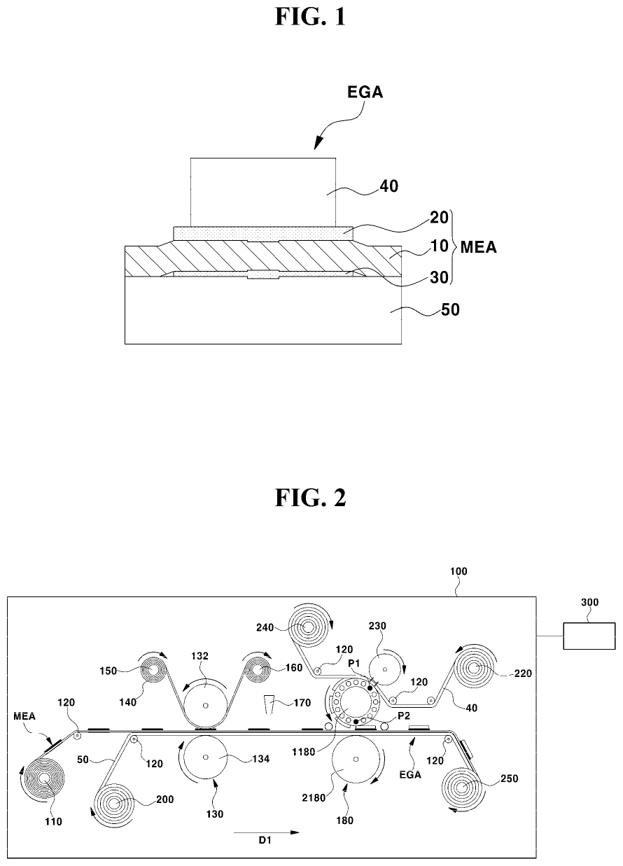

As illustrated in FIG. 1, an electricity-generating assembly (EGA) includes a membrane-electrode assembly (MEA) and a gas diffusion layer (GDL). The MEA includes an electrolyte membrane 10 formed of a polymer and a positive electrode 20 and a negative electrode 30 provided on both sides of the electrolyte membrane 10. In addition, an upper GDL 40 and a lower GDL 50 are disposed outside of the positive electrode 20 and negative electrode 30, respectively. As described above, the EGA is provided as a bonded structure of the MEA and the GDLs, in which the GDLs serve as supports of the MEA, such that the MEA may maintain the structural shape thereof.

The EGA fabrication is carried out using two processes of a roll-to-roll process and a hot pressing process, which are discontinuous from each other. Specifically, the lower GDL 50 is continuously bonded to the MEA using the roll-to-roll process. In addition, in a separate process, the upper GDL 40 is discontinuously bonded to the bonded structure of the MEA and the lower GDL 50 using the hot pressing process.

This fabrication method uses two separate and discontinuous processes and thus has drawbacks, such as a low fabrication rate and significantly low mass productivity.

In this regard, the present disclosure provides an EGA fabrication apparatus and method for simultaneously bonding the upper GDL and the lower GDL to the MEA in a single continuous process, thereby improving mass productivity and reducing fabrication costs.

As illustrated in FIG. 2, an EGA fabrication apparatus 100 according to the present disclosure may attach the upper GDL 40 and the lower GDL 50 to each other in a continuous process. In particular, an EGA fabrication method according to the present disclosure may include a roll-to-roll process. In FIG. 2, D1 indicates a progress direction or a flow direction of the process.

An MEA is wound in the form of a roll on an MEA unwinding part 110. The MEA unwinding part 110 is configured to be rotatable, and the MEA may be continuously supplied by the rotation of the MEA unwinding part 110. A plurality of rollers 120 may be disposed on a route of the MEA unwound from the MEA unwinding part 110. The rollers 120 are configured to adjust the tension of the MEA or guide the progress of the MEA.

An upstream press 130 is disposed downstream of the MEA unwinding part 110 in the progress direction D1 of the MEA. As a non-limiting example, the upstream press 130 may be a thermal press roll configured to be rotatable.

A protective film 140 and the lower GDL 50 may be attached to the continuously supplied MEA by the upstream press 130. In an implementation, the upstream press 130 includes an upper press 132 and a lower press 134, and the MEA is configured to pass between the upper press 132 and the lower press 134.

The protective film 140 is attached to the top surface of the supplied MEA. The protective film 140 is wound in the form of a roll on a rotatable protective film unwinding part 150. In response to rotation of the protective film unwinding part 150, the protective film 140 unwound from the film unwinding part 150 is supplied to pass between the upper press 132 and the MEA. In addition, the protective film 140 may be attached to the top surface of the MEA by the upper press 132. After the protective film 140 is attached to the MEA, a remaining scrap portion of the protective film 140 may be collected by a protective film scrap winding part 160.

The protective film 140 is configured to protect the MEA. When the MEA is exposed to high temperature, the MEA becomes adhesive and has a sticky property. Without the protective film 140, the MEA may be bonded to the upstream press 130, causing damage to the material of the MEA. Thus, in order to prevent the MEA from being damaged by the upstream press 130 of the thermal press roll or the like, the protective film 140 is attached to the MEA.

The protective film 140 may be coated with polytetrafluoroethylene (PTFE). As a non-limiting example, the protective film 140 may be formed of polyimide (PI), poly(ethylene 2,6-naphthalene dicarboxylate) (PEN), polyethylene terephthalate (PET), fiberglass, or the like coated with PTFE. Here, it is desirable to not use a silicone release coated protective film since the MEA may deteriorate due to contamination by silicone.

The lower GDL 50 may be attached to the bottom surface of the MEA. The lower GDL 50 is wound in the form of a roll on the rotatable lower GDL unwinding part 200. The lower GDL 50 continuously supplied by the rotation of the lower GDL unwinding part 200 may be attached to the bottom surface of the MEA by the rotating lower press 134 while passing between the MEA and the lower press 134. In some implementations, the plurality of rollers 120 may be disposed on a route of progress of the lower GDL 50 to guide the progress of the lower GDL 50.

In the progress direction D1 of the bonded structure (hereinafter, referred to as a “four-layered EGA”) in which the MEA and the lower GDL 50 are bonded, a downstream press 180 is disposed downstream of the upstream press 130. In an implementation of the present disclosure, the downstream press 180 includes an attachment roll 1180 and a lower roll 2180. The attachment roll 1180 and the lower roll 2180 may be configured to be rotatable to bond materials that are introduced therebetween.

According to the present disclosure, the attachment roll 1180 may selectively adsorb the upper GDL 40 cut to a certain size and bond the upper GDL 40 to the top surface of the four-layered EGA using the downstream press 180.

An electrode detection sensor 170 is disposed between the upstream press 130 and the downstream press 180. The electrode detection sensor 170 is configured to detect the four-layered EGA moving from the upstream press 130 to the downstream press 180. As a non-limiting example, the electrode detection sensor 170 may be a vision camera. As another non-limiting example, the electrode detection sensor 170 may be an infrared (IR) sensor. However, the electrode detection sensor 170 is not limited to the vision camera or the IR sensor, but may be implemented as other types of known sensors.

For example, the electrode detection sensor 170 may determine whether the four-layered EGA has reached the downstream press 180 by detecting an electrode pattern of the four-layered EGA. As will be described later, the result of the detection is transferred to a controller 300. The controller 300 is configured to communicate with components of the EGA fabrication apparatus 100 and may control operations of the components.

The attachment roll 1180 may prepare the upper GDL 40 so that the punched upper GDL 40 may reach the downstream press 180 at a point in time at which the four-layered EGA reaches the downstream press 180 in response to an entry detection signal of the electrode detection sensor 170. For example, in consideration of the position of the electrode detection sensor 170, the speed of each of the components of the EGA fabrication apparatus 100, the outer diameter of the attachment roll 1180, and the like, it will be assumed that the four-layered EGA reaches the downstream press 180 after 10 seconds that the four-layered EGA is detected by the electrode detection sensor 170. Then the punch roll 230 rotates to punch the upper GDL 40 so that the upper GDL 40 adhered and transported by the attachment roll 1180 after punched by a punch roll 230 may also reach the downstream press 180 to be bonded to the four-layered EGA after 10 seconds. That is, in response to the entry detection signal from the electrode detection sensor 170, the four-layered EGA moving in the progress direction D1 and the upper GDL 40 to be bonded to the four-layered EGA simultaneously meet on the downstream press 180.

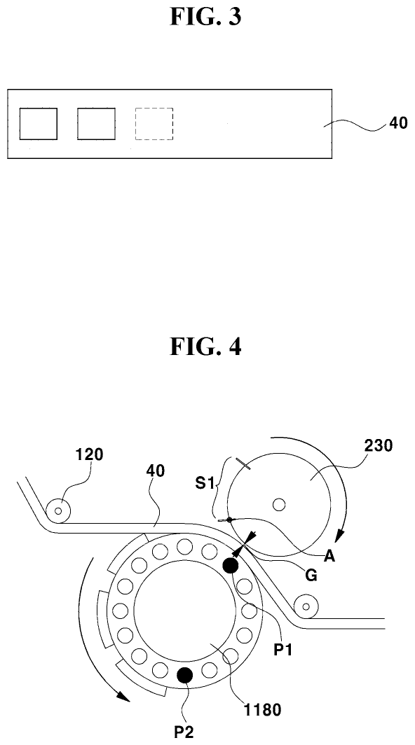

Specifically, as illustrated in FIG. 3, the upper GDL 40 is punched using the punch roll 230. The punch roll 230 is configured to punch the continuously supplied upper GDL 40 according to a predetermined size so that the punched portion of the upper GDL 40 may be attached to the top portion of an electrode, e.g., a positive electrode, of the MEA. The upper GDL 40 is wound in the form of a roll on a rotatable upper GDL unwinding part 220. One or more rollers 120 are positioned to guide the upper GDL 40.

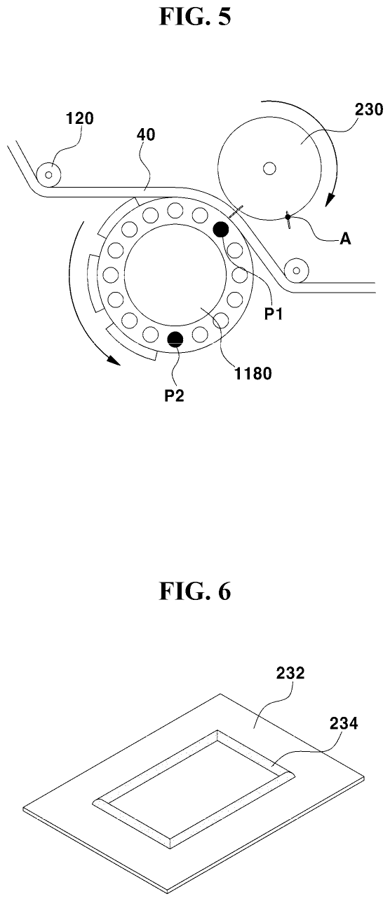

As illustrated in FIGS. 4 and 5, the upper GDL 40 moves between the attachment roll 1180 and the punch roll 230. The punch roll 230 is configured to have a predetermined gap G from the attachment roll 1180. The gap G between the punch roll 230 and the attachment roll 1180 may vary depending on the thickness of the upper GDL 40. Typically, the thickness of the upper GDL 40 may range from 100 μm to 1,000 μm. The gap G may be adjusted depending on the thickness of the upper GDL 40 actually used. When the gap G is too narrow, the upper GDL 40 may not pass through the gap G and be damaged. When the gap G is too wide, it may be difficult to punch the upper GDL 40 using the punch roll 230. Thus, the gap G is required to be set in an appropriate range.

Referring to FIG. 6, a punching plate 232 and a punching blade 234 are attached to a portion S1 of the outer circumference of the punch roll 230. The height of the punching blade 234 may range from 100 μm to 1,000 μm. The punching plate 232 having an appropriate thickness according to the thickness of the upper GDL 40 and the gap G between the attachment roll 1180 and the punch roll 230 may be used. The punching plate 232 may be attached to the punch roll 230 using a magnet.

Returning to FIGS. 4 and 5, the punching blade 234 is configured to be constantly located at an original point A of the punch roll 230. The punch roll 230 is fundamentally in a stationary state. The punch roll 230 is configured to rotate clockwise only when receiving a punching instruction from the controller 300 on the basis of the entry detection signal from the electrode detection sensor 170. The punching blade 234 that has rotated clockwise returns to the original point A by rotating counterclockwise after completing the punching.

The attachment roll 1180 selectively holds the upper GDL 40 punched using the punch roll 230 and transports the upper GDL 40 to a bonding position of the downstream press 180, so that the upper GDL 40 and the four-layered EGA are bonded. Here, the scrap portion (i.e., the remaining portion except for boxes drawn with solid lines and dotted lines) of the upper GDL 40 may be wound on and collected by an upper GDL winding part 240.

The attachment roll 1180 may hold the punched portions of the upper GDL 40 on the surface of the attachment roll 1180 through vacuum suction (or negative pressure suction). In particular, the attachment roll 1180 may hold the upper GDL 40 by selecting portions of, instead of the entirety of, a vacuum suction area provided on the attachment roll 1180. In this regard, according to an implementation of the present disclosure, the attachment roll 1180 includes holes 1182, conduits 1184, a rotary joint 1186, a vacuum line 1192, identification sensors 1194, valves 1196, and identifiers 1198a and 1198b.

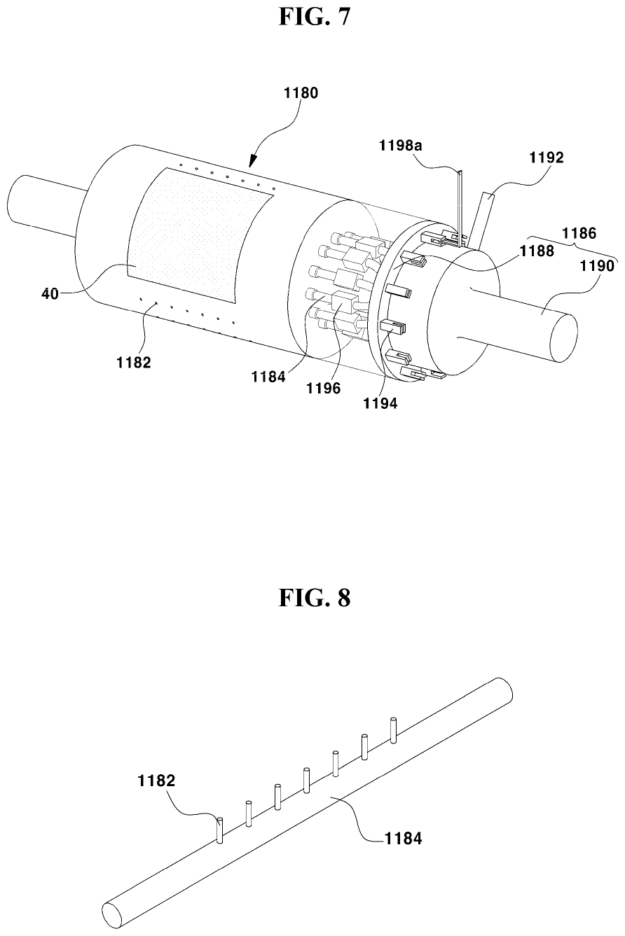

Specifically, referring to FIG. 7, a plurality of holes 1182 are provided in the outer circumferential portions of the attachment roll 1180. The upper GDL 40 punched using the punch roll 230 may be held through adsorption by vacuum provided through the plurality of holes 1182.

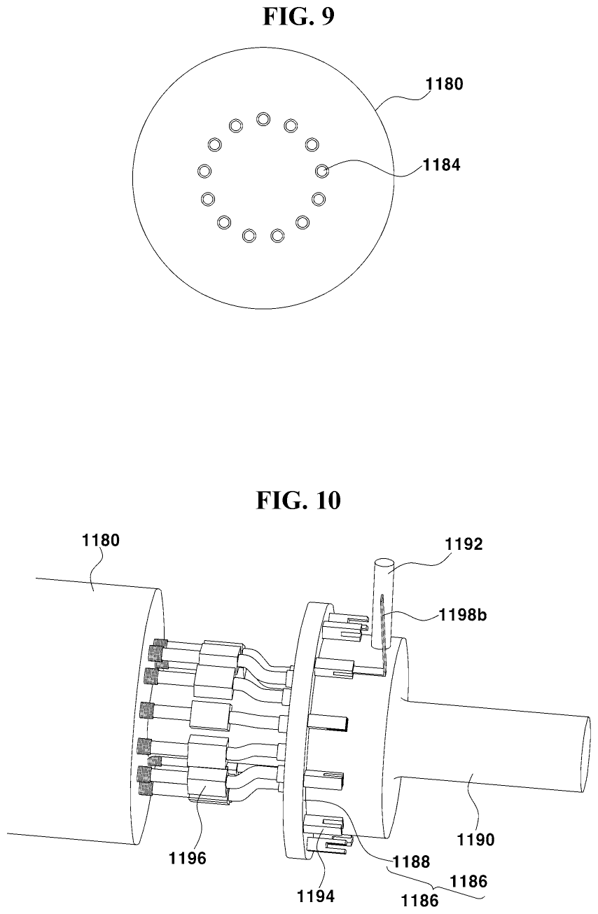

As described above, vacuum suction force may be partially generated in the attachment roll 1180. That is, as illustrated in FIG. 8, the attachment roll 1180 may be provided with the conduits 1184 to simultaneously provide vacuum to only the holes 1182 aligned in the longitudinal direction of the attachment roll 1180. In addition, as illustrated in FIG. 9, a plurality of conduits 1184 may be provided within the attachment roll 1180 in the circumferential direction of the attachment roll 1180 to selectively supply vacuum suction through each conduit 1184 aligned to a line in the longitudinal direction of the attachment roll 1180. Vacuum supplied to the conduits 1184 may be supplied to the conduits 1184 through the vacuum line 1192 provided in the attachment roll 1180.

The rotary joint 1186 of the attachment roll 1180 allows the rotating attachment roll 1180 to perform vacuum suction. In an implementation, the rotary joint 1186 includes a rotatable part 1188 and a fixed part 1190.

Additionally referring to FIG. 10, the fixed part 1190 is fixed instead of being rotatable. The vacuum line 1192 is connected to the fixed part 1190, and the identifiers 1198a, 1198b are mounted on the fixed part 1190. Vacuum is supplied into the fixed part 1190. Since the fixed part 1190 does not rotate, the vacuum line 1192 may be maintained without twisting, torsion, or the like. The identifiers 1198a, 1198b may be disposed on a first detection position P1 and a second detection positions P2, respectively, to determine a position in concert with the identification sensors 1194. For example, the identifiers 1198a, 1198b may be engaged with the identification sensors 1194 to determine which conduit has reached the first detection position P1 or the second detection position P2.

The rotatable part 1188 is configured to be rotatable about the fixed part 1190. Thus, a portion of the attachment roll 1180 including the identification sensors 1194, the conduits 1184, the holes 1182, and the like may freely rotate about the fixed part 1190.

Moreover, the valves 1196 are mounted on the conduits 1184, respectively. Accordingly, each of the valves 1196 may allow or block flow of vacuum to a specific conduit 1184. As a non-limiting example, the valves 1196 may be solenoid valves.

The identification sensors 1194 are mounted on the conduits 1184, respectively, to identify the respective conduits 1184. That is, opening or closing of the valves 1196 may be controlled based on the signals from the identification sensors 1194. As a non-limiting example, the identification sensors 1194 may be infrared (IR) sensors. Here, the type of the identification sensors 1194 is not limited to the IR sensor, and any known type of sensor performing a similar function may be used.

Described in detail, the conduits may operate independently of each other. It will be assumed that the first conduit and the second conduit among the conduits 1184 illustrated in FIG. 9 are adjacent to each other. The first conduit is associated with first holes aligned to a first longitudinal line, and the second conduit is associated with second holes aligned to a second longitudinal line. The first conduit is provided with a first identification sensor and a first valve, and the second conduit is provided with a second identification sensor and a second valve.

The operation of the attachment roll 1180 will be described in detail by referring to FIG. 4 or 5 again, in connection with the above description. The first identifier 1198a is provided on the fixed part 1190 to be located at the first detection position P1, i.e., a point in the circumference of the fixed part 1190. When the first identification sensor on the first conduit passes the first detection position P1 indicated by the first identifier 1198a, information regarding the passage is transferred to the controller 300. The controller 300 may instruct the first valve of the first conduit to be opened so that the first conduit adheres to the upper GDL 40 through vacuum provided through the first holes.

However, when all of the conduits 1184 passing through the first detection position P1 are configured to operate in this manner, a non-punched scrap portion of the upper GDL 40 (e.g., a scrap portion of the upper GDL 40 between and adjacent to the punched portions of the upper GDL 40) may also be adhered and be damaged, thereby making it difficult to carry out the process. Accordingly, the ability to selectively control the adhering by the area of the upper GDL 40 to be adhered is required.

Thus, when a rotation signal indicating start of rotation of the punch roll 230 is transferred to the controller 300, in addition to the position detection signal transmitted from the first detection position P1, the controller 300 controls the valve 1196 of the corresponding conduit 1184 to be opened. That is, in the above example, when the first conduit is at the first detection position P1 and the punch roll 230 is detected as rotating, the first valve is opened. In contrast, when the second conduit is at the first detection position P1, but the punch roll 230 is detected as not rotating, the second valve is not opened.

The rotation of the punch roll 230 is used as a reference for determination of whether to open the valve 1196 in this manner, because it is required to determine the area of the upper GDL 40 to be adhered while being cut by rotation of the punch roll 230. Timing of rotation of the punch roll 230 is determined so that the four-layered EGA and the upper GDL 40 simultaneously reach the downstream press 180 to be bonded in response to the entry detection signal from the electrode detection sensor 170. Put differently, the first detection position P1 is a start position of punching by the punch roll 230. When the adherence is started from the first detection position P1 at a point in time at which the above-described two signals, i.e., the position detection signal transmitted from the first detection position P1 and the rotation signal indicating the start of rotation of the punch roll 230, are simultaneously input, only a required area may be accurately adhered and fixed and the scrap portion of the upper GDL 40 may be prevented from being damaged, whereby a continuous process may be enabled.

In addition, the second identifier 1198b is provided on the fixed part 1190 to be located at the second detection position P2, i.e., a point in the circumference of the fixed part 1190. The second identifier 1198b is provided at a position directly before the punched portion of the upper GDL 40 is bonded to the four-layered EGA. When a specific identification sensor 1194, e.g., the first identification sensor, passes the second identifier 1198b, the controller 300 is configured to close the first valve. Accordingly, the upper GDL 40 adhered to the surface of the attachment roll 1180 may be detached from the attachment roll 1180.

The upper GDL 40 and the four-layered EGA are bonded while passing through the downstream press 180. When the upper GDL 40 remains attached to the attachment roll 1180 after upper GDL 40 and the four-layered EGA are bonded, the attachment roll 1180 will continue pulling the bonding-completed five-layered EGA (i.e., an assembly of the four-layered EGA and the upper GDL attached to the four-layered EGA) after the assembly has passed through the downstream press 180. This may damage the fabric, i.e., the assembly of the four-layered EGA and the upper GDL attached to the four-layered EGA. In order to prevent this, the upper GDL 40 is required to be detached from the attachment roll 1180 at the second detection position P2. Since the second detection position P2 is only related to release of vacuum suction, the detachment may be controlled by a single signal.

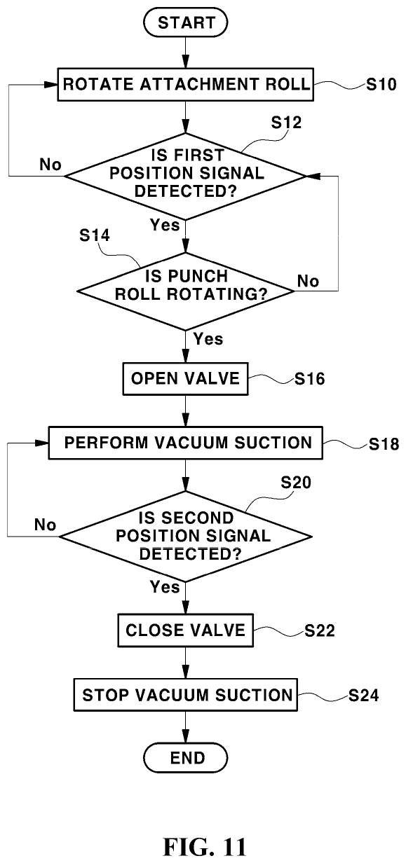

Overall, the operation of the attachment roll 1180 may be described as illustrated in FIG. 11.

When the attachment roll 1180 starts to rotate at S10, the controller 300 determines whether a first position signal from the first conduit among the conduits 1184 is detected at S12. The first position signal is a signal detected when the first identification sensor in the first conduit meets the first identifier 1198a in the first detection position P1.

When the first position signal is not detected, the controller 300 returns to S10. When the first position signal is detected, the controller 300 determines whether the punch roll 230 is rotating before opening the first valve at S14. As described above, it is intended to prevent the scrap portion from also being adhered.

When the punch roll 23 is not rotating, the controller 300 returns to S12. When the punch roll 230 is determined to be rotating, the controller 300 instructs the first valve in the first conduit to be opened at S16. Consequently, vacuum suction is started through the holes 1182 aligned with the first detection position P1 at S18.

Subsequently, the controller 300 determines whether a second position signal is detected at S20. For example, the second position signal is a signal detected when the first identification sensor in the first conduit meets the second identifier 1198b in the second detection position P2. When the first conduit performing vacuum suction reaches the second detection position P2, the controller 300 is configured to close the first valve of the first conduit at S22. Consequently, the vacuum suction of the first conduit is stopped, and the upper GDL 40 may be completely detached from the attachment roll 1180, and vacuum suction is stopped at S24.

The EGA fabricated in this process may be wound in the form of a roll by an EGA winding part 250.

As described above, the controller 300 is configured to control the operation of the EGA fabrication apparatus 100. The controller 300 may control the operation of the respective unwinding parts 110, 150, 200, 220, the winding parts 160, 240, 250, the presses 130, 180, and the punch roll 230. In addition, the controller 300 may collect information detected by the electrode detection sensor 170 and the identification sensors 1194 and control the operation of the EGA fabrication apparatus 100 based on the collected information. Also, the controller 300 may control the operation of the attachment roll 1180, supply of vacuum, and the operation of the valves 1196. The controller 300 may be a combination of separate controllers respectively controlling a portion of the components of the EGA fabrication apparatus 100 or a single integrated controller.

It will be apparent to those skilled in the art that the terms “upper” or “lower” used herein refer to relative positions, which are interchangeable, and may be expressed in other forms such as “left” and “right” and “first” and “second”.

The EGA fabrication apparatus according to the present disclosure includes the attachment roll 1180 and thus may accurately and continuously supply and attach the upper GDL 40 to an intended position on the EGA. In this manner, a continuous process is enabled, and bonding operations of the upper GDL 40 and the lower GDL 50 may be provided as a single process, thereby maximizing mass productivity.

The GDL is a porous material and is required to have a certain level of suction force at a constant level for adherence and fixing. However, a typical vacuum suction roll rather than the attachment roll 1180 according to the present disclosure performs vacuum suction through the entire surface of the roll. When any portion of the area of the vacuum suction roll to which vacuum is provided is not sealed airtight, suction force of the suction roll is reduced. This has been a reason that makes it difficult to adhere to the GDL using a typical vacuum suction roll.

In contrast, the EGA fabrication apparatus 100 according to the present disclosure is configured as described above such that the vacuum suction holes in the surface of the attachment roll 1180 are divided into sections and may operate according to the section so that only a necessary portion may be adhered.

Although the exemplary embodiments of the present disclosure have been described for illustrative purposes, those skilled in the art will appreciate that various modifications, additions, and substitutions are possible, without departing from the scope and spirit of the present disclosure as disclosed in the accompanying claims.

1. An electricity-generating assembly (EGA) fabrication apparatus comprising:
a downstream press, wherein the downstream press comprises an attachment roll configured to attach a second gas diffusion layer (GDL) to a second surface of a membrane-electrode assembly (MEA) with a first GDL attached to a first surface of the MWA;
wherein the attachment roll is rotatable and configured to receive the second GDL having a predetermined size, and to attach the GDL to the second surface of the MEA at predetermined distances.

2. The EGA fabrication apparatus according to claim 1, further comprising a punch roll disposed adjacent to the attachment roll such that the second GDL continuously supplied to the attachment roll is located between the punch roll and the attachment roll,
wherein the punch roll is configured to rotate and to cut the second GDL into predetermined sizes.

3. The EGA fabrication apparatus according to claim 2, wherein the attachment roll is configured to hold the second GDL on a surface of the attachment roll.

4. The EGA fabrication apparatus according to claim 3, wherein the attachment roll is configured to hold the second GDL through vacuum suction.

5. The EGA fabrication apparatus according to claim 4, wherein the attachment roll comprises:
a vacuum line through which vacuum is supplied;
a plurality of conduits disposed in the attachment roll and spaced apart from each other in a circumferential direction of the attachment roll, wherein each conduit has a plurality of holes; and
a plurality of valves provided on the conduits, the plurality of valves being configured to open and close to selectively connect the conduits to the vacuum line.

6. The EGA fabrication apparatus according to claim 5, wherein the attachment roll further comprises:
a fixed part to which the vacuum line is connected; and
a rotatable part configured to rotate about the fixed part and comprising the plurality of conduits and the plurality of valves,
wherein an identification sensor is provided on each of the plurality of conduits, at least two identifiers are disposed on the fixed part to operate in concert with the identification sensor, and the at least two identifiers comprise a first identifier and a second identifier.

7. The EGA fabrication apparatus according to claim 6, wherein opening of the plurality of valves is determined based on detection of the first identifier by the identification sensor and rotation of the punch roll.

8. The EGA fabrication apparatus according to claim 6, wherein closing of the plurality of valves is determined based on detection of the second identifier by the identification sensor.

9. The EGA fabrication apparatus according to claim 2, further comprising an electrode detection sensor disposed upstream of the downstream press, the electrode detection sensor being configured to detect arrival of the continuously supplied MEA;
wherein the electrode detection sensor is configured to provide position information of the MEA so that when the MEA is supplied to the downstream press, the MEA meets a punched portion of the second GDL.

10. The EGA fabrication apparatus according to claim 1, wherein the EGA comprises:
an electrolyte membrane;
a positive electrode attached to a first surface of the electrolyte membrane; and
a negative electrode attached to a second surface of the electrolyte membrane, the first surface being opposite to the second surface.

11. An electricity-generating assembly (EGA) fabrication method comprising:
continuously supplying a membrane-electrode assembly (MEA) by an MEA unwinding part;
attaching a first gas diffusion layer (GDL) to a first surface of the MEA using an upstream press disposed upstream in a flow direction of the MEA, wherein the first GDL is continuously supplied;
attaching a second GDL to a second surface of the MEA using a downstream press disposed downstream in the flow direction of the MEA; and
obtaining an EGA by attaching the second GDL to the MEA.

12. The EGA fabrication method according to claim 11, wherein the downstream press comprises:
a rotatable attachment roll; and
a rotatable lower roll configured such that the MEA to which the first GDL is attached passes between the rotatable lower roll and the rotatable attachment roll.

13. The EGA fabrication method according to claim 12, wherein the attachment of the second GDL comprises:
continuously supplying the second GDL to the rotatable attachment roll;
punching the second GDL into predetermined sizes using a punch roll; and
attaching punched portions of the second GDL to the MEA to which the first GDL is attached when the MEA is supplied to the rotatable attachment roll.

14. The EGA fabrication method according to claim 13, wherein an electrode detection sensor is disposed upstream of the rotatable attachment roll;
wherein the electrode detection sensor is configured to detect approach of the MEA to which the first GDL is attached to the rotatable attachment roll using the electrode detection sensor; and
when the MEA to which the first GDL is attached is supplied to the rotatable attachment roll based on detection of the electrode detection sensor, the punched portions of the second GDL are supplied.

15. The EGA fabrication method according to claim 14, wherein the attachment of the second GDL comprises:
detecting the rotatable attachment roll located at a first detection position;
determining whether the punch roll is rotating; and
supplying vacuum to a first portion of the rotatable attachment roll in response to the rotation of the punch roll.

16. The EGA fabrication method according to claim 15, further comprising:
detecting the rotatable attachment roll located at a second detection position; and
blocking supply of vacuum to the first portion of the rotatable attachment roll.

17. The EGA fabrication method according to claim 11, wherein obtaining the EGA comprises winding the EGA into a roll.

18. The EGA fabrication method according to claim 11, further comprising, before the attachment of the second GDL, continuously attaching a protective film on the second surface of the MEA.

19. The EGA fabrication method according to claim 13, further comprising collecting a scrap portion of the punched second GDL using a second GDL scrap winding part.
